(19) United States
(12) Patent Application Publication
(10) Pub. No.: US 2025/0165646 A1
(43) Pub. Date: May 22, 2025

(54) SYSTEMS AND METHODS FOR ANONYMIZING LOCATION DATA AND DATA SHREDDING

(71) Applicant: Wells Fargo Bank, N.A., San Francisco, CA (US)

(72) Inventors: Pankaj Parekh, San Francisco, CA (US); Steve Perez, San Francisco, CA (US); Bill Wurz, San Francisco, CA (US)

(21) Appl. No.: 17/087,241

(22) Filed: Nov. 2, 2020

(51) Int. Cl. G06F 21/62; G06Q 20/32; G06Q 20/36; G06Q 30/0201; G06Q 30/0204; G06Q 30/0226; G06Q 40/12; G07C 9/00; H04L 67/52; H04L 67/54

(52) U.S. Cl. CPC G06F 21/6254; G06Q 20/326; G06Q 20/36; G06Q 30/0201; G06Q 30/0205; G06Q 30/0226; G06Q 40/12; G07C 9/00; H04L 67/52; H04L 67/54

(57) ABSTRACT

Systems and methods for anonymizing user data are described herein. A system for anonymizing user data includes a user device. The user device includes a network interface coupled to a processing circuit structured to display a mobile application graphical user interface depicting a field for a log-in credential. The processing circuit is further structured to receive a log-in credential of a user and cross-reference the received log-in credential to authenticate the user. The processing circuit is further configured to generate a unique value void of personally identifiable information regarding the user, determine a current location of the user, and associate the unique value with the current location to create a data packet. The processing circuit further configured to transmit the data packet to the provider computing system to quantify a number of users in a predefined area.

### TECHNICAL FIELD

The present disclosure relates to anonymizing location and/or other potentially sensitive data, shredding non-anonymized location or other potentially sensitive data, and among other features, incrementing a counter to determine a number of people in various areas of interest in order to beneficially limit data transmission of personally identifiable information (PII) and increase security of a user's PII yet still tracking potentially valuable user information.

### BACKGROUND

Various entities indefinitely store user transaction and location data. The transaction and location data may be associated with personally identifiable information. A potential problem is that these and other entities may be unable to use this data due to the data being linked to the personally identifiable information. Valuable services and products that may be determined and recommended based on the user transaction and/or location data are then bypassed resulting in missed opportunities. Identifying and using location and other potentially sensitive data divorced from personally identifiable information would be beneficial.

### SUMMARY

One embodiment relates to a system for anonymizing user data, the system comprises a user device. The user device comprises a network interface structured to facilitate communication with a provider computing system via a network. The network interface is coupled to a processing circuit. The processing circuit includes a processor coupled to a memory storing instructions that, when executed by the processor, cause the processing circuit to perform operations. The operations include to display a mobile application graphical user interface depicting a field for a log-in credential. The operations further include to receive a log-in credential of a user associated with the mobile application, and cross-reference the received log-in credential with a stored log-in credential to successfully authenticate the user into the mobile application. The operations further include to generate a unique value void of personally identifiable information regarding the user based on successful authentication. The operations further include to determine a current user location based on location data associated with the user device. The operations further include to associate the current user location with the unique value to generate a data packet. The operations further include to transmit the data packet to the provider computing system to quantify a number of users in a predefined area

Another embodiment relates to a method for anonymizing user location information. The method includes determining and maintaining, by a provider computing system, a plurality of geospatial areas of interest; providing, by the provider computing system, a plurality of provider institution client applications to a plurality of user devices; based on a successful authentication into a provider institution client application of a provider institution client application, receiving, by the provider computing system, a unique value and a current location of a user device associated with the provider institution client application that was successfully authenticated into, the unique value void of personally identifiable information regarding a user associated with the user device; matching, by the provider computing system, the current location of the user device to a geospatial area of interest of the plurality of geospatial areas of interest; and incrementing, by the provider computing system, a counter regarding an occupancy of the geospatial area of interest based on the match.

Another embodiment relates to a system. The system includes a provider computing system including a network interface and a processing circuit. The network interface is structured to facilitate communication with a plurality of user devices via a network. The processing circuit includes a processor and a memory storing instructions that, when executed by the processor, cause the processing circuit to: determine a plurality of geospatial areas of interest; receive, from the plurality of user devices, location information regarding locations of the plurality of user devices based on a successful authentication into a provider institution client application deployed on each of the plurality of user devices that cause a unique value void of any personally identifiable information to be received with the location information; verify the received unique value from the plurality of user devices; sort the received location information associated with verified unique values to correlate the received location information to the plurality of geospatial areas of interest; and increment an occupancy counter for a geospatial area of interest based on the received location information to track occupancy in the geospatial area of interest.

This summary is illustrative only and is not intended to be in any way limiting. Other aspects, inventive features, and advantages of the devices or processes described herein will become apparent in the detailed description set forth herein, taken in conjunction with the accompanying Figures, wherein like reference numerals refer to like elements.

### BRIEF DESCRIPTION OF THE FIGURES

FIG. 1 is a diagram of a location data collection and data shred computing system, according to an example embodiment.

FIG. 2 is a flow diagram of a method for anonymizing and transmitting location data, according to an example embodiment.

FIG. 3 is a flow diagram of a method for identifying, incrementing a counter, and modifying geospatial areas of interest to identify a plurality of users, according to an example embodiment.

FIG. 4 is a flow diagram of a method for anonymizing and transmitting transaction data, according to an example embodiment.

FIG. 5 is a flow diagram of a method for transmitting rewards to a user based on a user location, according to an example embodiment.

### DETAILED DESCRIPTION

Referring generally to the Figures, systems and methods for generating and assigning a unique value to a user to anonymously obtain location data, and the utilization of the anonymously obtained location data to, for example, count users in a geospatial area of interest are shown and described according to various embodiments herein. The systems and methods of the present application enhance the collection and analysis of user location and other potentially valuable data that may be linked to potentially sensitive information by generating a unique value at the user device that is divorced from the potentially sensitive information. The systems and methods of the present application further describe anonymously tracking certain desired information by shredding certain other acquired and linked data (e.g., personally identifiable information) while retaining the certain desired information (e.g., generic transaction and location information) to eliminate the storage and usage of user identifiable information or personally identifiable information (PII).

A location data collection and data shred computing system includes a provider institution computing system coupled to a user device. The provider institution computing system may be associated with a provider institution, such as a financial institution that offers various financial products and services. Upon the user accessing a provider institution client application on the user device and successfully authenticating into the client application by the user providing log-in credentials (e.g., username and password, biometric scan), the client application generates a unique value to represent the user that is void of any PII. The unique value may then be associated with the current user location and transmitted to the provider institution computing system. By assigning a unique value that is divorced from PII, the provider institution computing system is able to gain or acquire location information anonymously. The unique value may also be applied to transaction data. For example, a unique value may be generated by the user device each time a mobile wallet transaction is performed. Accordingly, the unique value indicates that (1) a transaction was performed via the user device and (2) the location of the transaction. Beneficially, by receiving the anonymized transaction data, the provider institution computing system may determine trends in sales in certain areas or at certain merchants (e.g., places that are frequented, areas that are frequented, areas that are not frequented, etc.). Additionally, by using a unique value associated with a location in place of user PII, the user device limits the amount of potentially sensitive information transmitted to the provider computing system. A reduction in the amount of information transmitted may further lead to a reduction in bandwidth needed to transmit the user location and/or transaction information. Moreover, excluding PII in the data transmissions helps to reduce the risk of undesired fraudulent activity occurring given that the unique value is divorced from the PII of the user.

In one implementation embodiment, the unique value and user location data are transmitted to the provider institution computing system. Based on the location data aligning with a geospatial area of interest, the provider institution computing increments a counter to count people or occupancy in that area over a predefined time period. Alternatively, a user may provide an explicit input via the provider institution client application to allow their location to be tracked by the provider institution computing system. In which case, the provider institution computing system receives the location input and increments the counter for that location. The location information is then deleted such that only the counter is utilized to minimize computer storage requirements yet still keep tracking of occupancy in various locations. A geospatial area of interest as described herein is a geographic area of interest for tracking occupancy over a predefined time period where occupancy refers to visitors to the area and not necessarily home residency. Thus, a same user may be counted multiple times in a given predefined time period. In other cases, the unique value may be used to filter out duplicates such that the same user is not counted multiple times. The geospatial area of interest can include information about businesses within the area (e.g., business name, type of business), public transportation through the area, etc. The geospatial area of interest may also be referred to as an area of interest, a predefined area of interest, and a geo-fenced area of interest herein. A geospatial area of interest can include a town, strip mall, sports arena, etc. When a unique value and user location indication are received by the provider institution computing system, the data is sorted depending on the user location being within a geospatial area of interest. Beneficially, by incrementing a counter for the determined geospatial area of interest, the provider institution computing system can determine the number of authenticated users in a particular area. For example, the provider institution can make strategic business decisions, such as whether to place an ATM in a particular area based on the determined occupancy or visitors in that area. Additionally, by sorting the unique values by the associated location as the data is received, further searches, filtering, or queries of the received data can be done more efficiently, as the data is already sorted based on location.

In some embodiments, the user can authorize the mobile application to transmit personally identifiable information along with the location and/or transaction information to the provider computing system. This can be beneficial to the user, as the provider institution computing system can provide the user with rewards based on interests determined by the location and/or transaction information of the user. This can further be beneficial to the provider institution to, for example, determine location and/or transaction trends for different demographics (e.g., women aged 25-35 years). In this instance and to reduce the risk of fraudulent activity occurring with the transmitted PII, the user data can be shredded after a determined period of time (e.g., 1 hour, 1 day, 1 week, 1 year) by the provider institution computing system in order to impart anonymity to the data. By automatically deleting certain PII data from the memory of the provider institution computing system, an increase in memory storage may be realized. The shredding of the data can include deleting all user data or deleting all user personally identifiable information and maintaining the anonymized data (e.g., location, unique value, time). Shredding user data after a defined period of time is beneficial to the user as it lowers the risk of user personally identifiable information being compromised. Further, and beneficially for the provider institution, the regular shredding of user information allows for a lower requirement for memory storage of the provider institution computing system. These and other features and benefits are described more fully herein.

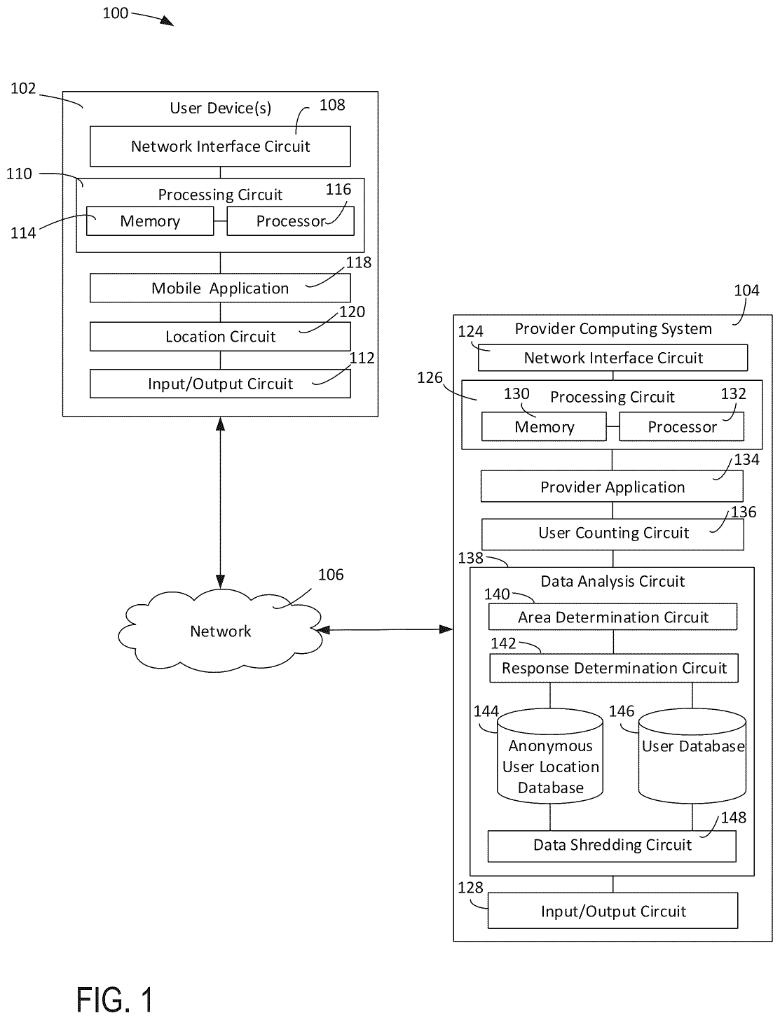

Referring now to FIG. 1, a block diagram of a location data collection and data shred computing system 100 for collecting and analyzing user location and other data is shown according to an example embodiment. The system 100 includes a user device 102 coupled to a provider institution computing system 104 via a network 106.

The user device 102 may be a computing device, such as a wearable or non-wearable computing device. Wearable computing devices refer to any type of device that an individual wears including, but not limited to, a watch (e.g., a smart watch), glasses (e.g., eye glasses, sunglasses, smart glasses, etc.), bracelet (e.g., a smart bracelet), etc. The user device 102 may also by other types of computing devices including, but not limited to, a phone (e.g., smart phone), a tablet, a laptop, a desktop computer, a personal digital assistant, etc. In the example shown, the user device 102 is a mobile device, such as a smartphone.

The user device 102 is shown to include a network interface circuit 108, a processing circuit 110, a mobile application 118, a location circuit 120, and an input/output circuit 112. The network interface circuit 108 is configured to couple to and establish connections with other computing systems via the network 106. The network interface circuit 108 includes program logic that facilitates connection of the user device 102 to the network 106. For example, the network interface circuit 108 may include any combination of a wireless network transceiver (e.g., a cellular modem, a Bluetooth transceiver, a Wi-Fi transceiver) and/or a wired network transceiver (e.g., an Ethernet transceiver). In some arrangements, the network interface circuit 124 includes the hardware and machine-readable media sufficient to support communication over multiple channels of data communication. Further, in some arrangements, the network interface circuit 108 includes cryptography capabilities to establish a secure or relatively secure communication session in which data communicated over the session is encrypted.

To provide certain functions of the user device 102, the network interface circuit 108 provides a relatively high-speed link to the network 106, which may be any combination of a local area network (LAN), an intranet (e.g., a private banking or retailer network), the Internet, or any other suitable communications network, either directly or through another external interface.

The processing circuit 110 includes a memory 114 coupled to a processor 116. The memory 114 includes one or more memory devices (e.g., RAM, NVRAM, ROM, Flash Memory, hard disk storage) that store data and/or computer code for facilitating the various processes described herein. That is, in operation and use, the memory 114 stores at least portions of instructions and data for execution by the processor 116 to control the functionality of the processing circuit 110. Moreover, the memory 114 may be or include tangible, non-transient volatile memory or non-volatile memory. The processor 116 may be implemented as one or more processors, application specific integrated circuits (ASICs), field programmable gate arrays (FPGAs), digital signal processors (DSPs), groups of processing components, or other suitable electronic processing components. As such, the user device 102 is configured to run a variety of application programs and store associated data in a database of the memory 114. One such application may be the mobile application 118.

The mobile application 118 may be provided by, hosted by, or otherwise coupled to the provider computing system 104, such that the application 118 may be also referred to as a provider client application 118 or provider institution client application 118 herein. The mobile application 118 is communicably coupled via the network circuit over the network to the provider institution computing system 104. In one embodiment and as shown, the mobile application 118 is a mobile banking application. In other embodiments, the mobile application 118 may take different forms commiserate with the provider institution (e.g., mobile wallet application, etc.). The mobile banking application 118 is structured to facilitate and permit conductance of transactions and management of accounts held by the user (e.g., at the provider institution associated with the provider institution computing system and/or other financial institutions). The mobile application 118 may be able to provide the user with the ability to locate automated teller machines (ATMs), transfer money between accounts, view balances of accounts, provision payment accounts for mobile wallet functionality, perform transactions using a provisioned payment account (e.g., via a mobile wallet), etc. The mobile application 118 is structured to track transactions made by the user either by using a physical payment card (e.g., debit card, credit card), or by mobile wallet (e.g., via a coupling to a mobile wallet application or the mobile application being configured as including a mobile wallet functionality). In some embodiments and as alluded to above, the mobile application 118 includes or is otherwise associated with a mobile wallet implemented on the user device. For example, the mobile application 118 may include a mobile wallet circuit therein that facilitates communications via the user device to a mobile wallet computing system (e.g., the provider institution computing system) enabling access to a user mobile wallet. In such embodiments, the mobile application 118 is structured to permit mobile wallet users to engage in transactions through the initiation of communications with, for example, a merchant point of sale (POS) device. For example, in some embodiments, the mobile application 118 includes a payment application facilitating exchange of mobile wallet credentials (e.g., tokenized account information) with the POS device. In this regard, the mobile application 118 may interface with a near field communications (NFC) chip controller to exchange the mobile wallet credentials.

The mobile application 118 may be downloaded by the user device 102 prior to its usage. The mobile application can hard coded into the memory 114 of the user device 102, or be a web-based interface application such that the user device 102 may provide a web browser to the application, which may be executed remotely from the user device 102. In the latter instance, the user may have to log onto or access the web-based interface before usage of the application. Further, and in this regard, the mobile application 118 may be supported, at least partly, by a separate computing system including one or more servers, processors, network interface circuits, etc. that transmit certain features and functionalities to the user device 102. In certain embodiments, the mobile application 118 includes an application programming interface (API) and/or a software development kit (SDK) that facilitate the integration of other applications with the mobile application 118. In the example shown, the mobile application 118 is downloaded to the user device 102, stored by the memory 114, and executed by the processor 116.

The mobile application 118 is structured to generate graphical user interfaces depicting fields that enable the user to provide log-in credentials, and further gain access to the mobile application 118. The fields can be free fields, single line text fields, etc. The log-in credentials can include a username and password, a payment account number and personal identification number (PIN), biometric scan (e.g., face identification, finger print identification), etc. In one embodiment, a field is provided on a graphical user interface generated by the mobile device 118 for receiving a log-in credential. The mobile application 118 is further structured to cross-reference the received log-in credentials with log-in credentials stored in memory 114. For example, multiple users may have accounts with the mobile application 118. Credentials for each user are stored in the memory 114. Upon receiving credentials, the mobile application 118 cross-references or searches the stored credentials for a match. Based on a match of received and stored credentials, that user is successfully authenticated into the mobile application 118. The mobile application 118 can determine an unsuccessful log-in by an inability to identify and match the received log-in credentials with stored log-in credentials.

The mobile application 118 may generate a graphical user interface that provides the user with various options regarding the information collected by the mobile application 118 (e.g., via one or more fields and settings). For example, the user can choose to restrict the mobile application 118 from transmitting any or certain types user PII to the provider institution computing system 104 (e.g., only first name and last name initial plus the location may be transmitted, etc.). In another example, the user can choose to allow the mobile application 118 to transmit user PII to the provider computing system 104 and instruct shredding of the PII after a set period of time (e.g., 1 hour, 1 day, 1 week, 1 year). The options regarding the collected information can be provided to the user via the mobile application 118 of the user device 102 in many forms (e.g., drop-down menu, list of check boxes). In some embodiments, the generated graphical user interface can include a text box explaining the benefits of allowing the mobile application 118 to transmit user PII to the provider institution computing system 104. For example, the generated graphical user interface can include the benefits of future rewards gained based on the determined location and/or transactions of the user.

In some embodiments, the mobile application 118, upon receiving approval to transmit particular PII to the provider computing system 104, can generate a graphical user interface that provides the user with the ability to enter demographic information (e.g., age, gender). The graphical user interface provided by the mobile application of the user device 102 can be in many forms (e.g., drop-down menu, list of check boxes). The received demographic information can subsequently be transmitted to the provider computing system 104.

The mobile application 118 is structured to generate a unique value, as will be described in greater detail below, upon the user entering log-in credentials and a successful authentication of the received log-in credentials. In some embodiments, the mobile application 118 can determine an unsuccessful log-in by an inability to cross-reference the received log-in credentials with stored log-in credentials. In this instance, the mobile application 118 may not generate a unique value. In one embodiment, the mobile application 118 generates a unique value before entering log-in credentials. For example, when the user opens the mobile application 118 on the user device 102, a unique value can be generated. In another embodiment and as primarily described herein, the mobile application 118 generates the unique value responsive to a successful authentication into the mobile application 118 (e.g., based on the received user log-in credentials).

The mobile application 118 is further structured to generate a unique transaction indicator or value, as described in greater detail below, when it is determined the user has completed or likely completed a transaction. In some embodiments and as described above, the mobile application 118 is a part of or includes a mobile wallet application. In these instances, the mobile application 118 can be notified by an indicator that a transaction has been completed. For example, the mobile application 118 can receive a notification that a transaction has been completed by the user void of any transaction specific information.

In some embodiments, the mobile application 118 provides a transaction summary (e.g., merchant name, location, transaction value, time) regarding a transaction. For example, the mobile application 118 can receive a transaction summary including the name of the merchant where the transaction was completed, the amount of money spent in the transaction, and the time the transaction was completed. Based on this information, the mobile application 118 can create a unique transaction identifier, associate the unique transaction identifier with a current user location, and send the associated unique transaction identifier and current user location to the provider computing system 104. In some embodiments, a data packet, as described below, including the unique transaction identifier, user location, and transaction information can be sent to the provider computing system 104.

The mobile application 118 may be structured to infer that a transaction has occurred (i.e., without receiving an explicit indication of a completed transaction). For example and in one embodiment, the mobile application 118 is structured to infer a transaction has or likely has occurred by the duration (e.g., 5 minutes, 15 minutes, 1 hour) that the user device 102 has been in a single location as indicated by the location circuit 120 and that the location corresponds with a merchant location. For example, the location circuit 120 can notify the mobile application 118 that the user device 102 has been in a particular geospatial area of interest for a predefined period of time (e.g., twenty minutes). Based on this information correlating with a known or identified merchant location, the mobile application 118 can infer that a transaction has taken place. This can be beneficial in determining shopping habits of users who complete transactions at a particular merchant, or visit a particular area.

The unique value and/or unique transaction identifier may be included with location information and/or transaction information in a data packet, also referred to as a payload. In this regard, the terms “data packet” or “payload” refer to the aggregate of information sent to the provider institution computing system 104 along with the unique values. In some embodiments and as described below where the location or transaction information is incorporated into the unique value, the payload may be the unique value. Examples of other information included in the data packet may include non-user identifiable information, such as time information, date information, transaction information (merchant name, price information, etc.), and so on. In some embodiment, the mobile application 118 may encrypt the payload before transmission to the provider computing system for added security. The provider institution computing system 104 may then decrypt the payload to reveal the included information. Accordingly, the mobile application 118 may include encryption keys or processes.

As mentioned above, the mobile application 118 is structured to generate unique values and unique transaction indicators or values. The unique value is a unique value representative of confirmed or authenticated user (e.g., when the user is authenticated into the mobile application 118). The unique transaction identifier is a value that anonymously indicates a suspected/determined transaction. Accordingly, the unique value and transaction values are representative of an authentication of the user and an inferred transaction without using PII. Beneficially, a provider institution can anonymously track where users of the mobile application 118 visit and where they shop via the unique value and unique transaction values. Additionally, the unique values can be a beneficial tool in determining habits of users. For example, users can maintain a single unique value or unique transaction identifier for an extended period of time (e.g., 1 day, 1 week, 1 month, indefinitely). In this instance, the provider can then anonymously determine patterns in user locations and in shopping trends.

In one embodiment and as mentioned above, the unique value is generated by the mobile application 118 based on a successful authentication into the mobile application 118. The unique value may be dynamically generated each time the application 118 is accessed or according to another frequency (e.g., time, uses, etc.). Alternatively, the unique value may be static in nature (described below). If the unique value is static in nature, the unique value is simply recalled or retrieved after a successful authentication into the mobile application 118. In another alternate embodiment, the unique value is generated (if dynamic) or retrieved (if static) before authentication into the mobile application 118 (e.g., simply opening the application without accessing the application). In some embodiments, the unique values and unique transaction indicators are randomly generated via a random number or alpha-numeric generator (e.g., XXXX1111KKKKK, etc.).

In some embodiments, the unique values may and unique transaction indicators may incorporate the location and/or transaction data into the value itself. For example, the mobile application 118 may receive information indicating that a transaction was completed by the user utilizing a debit card at a merchant named “Sammy's Pastries” for an amount of $5.12 at 8:34 AM. In this instance, the unique transaction value format may incorporate the transaction information by utilizing a short hand of payment type (e.g., debit card as DC), the first and last letter of the merchant name (e.g., SS), four digits of a transaction amount, and the time of purchase in military time giving a unique transaction indicator of “DCSS05120834”. This transaction information may be incorporated into the unique value as a way to verify the authenticity of the unique value (i.e., values that do not conform to this nomenclature are disregarded) against the transaction data included in the data packet with the unique value.

A specific format of the unique value may be used in order for the provider institution computing system 104 to verify the authenticity of the unique value. For example, limited use keys or other keys may be periodically received by the user device 102 from the provider computing system 104 that are used to generate the unique value. Based on the keys or LUKs, the provider computing system 104 can authenticate the unique value. For example, the unique value may be generated using a key and an algorithm (an encrypted unique value). Then, the provider computing system 104 may use the same or a different algorithm to decrypt the unique value. The key may be periodically replaced, such as based on time or uses, by the provider computing system 104 (i.e., by transmitting the replacement key and subsequently causing the user device to delete the existing key(s) from the user device). As another example, a specific format of the unique value may be used (e.g., sixteen digit, etc.). Beneficially, the use of the LUKs and other specific ways to generate unique values avoids spoofing of these values.

In some embodiments, the user is assigned a single unique value and/or unique transaction identifier value that is used indefinitely (static in nature). For example, when the user first accesses the mobile application 118 on a user device 102, the mobile application may generate a unique value that is then stored in the mobile application 118 (i.e., a one-time generation). This unique value may then be transmitted with updated location data (i.e., the payload) every time the user accesses the mobile application 118. In some embodiments, the unique value may be originally transmitted with a device identifier (e.g., phone number, device ID) to the provider computing system 104. In these instances, the provider institution computing system 104 may then hold this information separate from location data. In some embodiments, the provider computing system 104 may then ping the mobile application 118 to receive an updated location of the user by referencing the unique value that may be associated with a device identifier. This can be beneficial in anonymously determining location trends of users who reside in a particular area.

The location circuit 120 is structured to determine a location of the user device 102. For example, location circuit 120 may receive location data and determine a location of the user device 102 based on the location data. In one embodiment, the location circuit 120 may include a global positioning system (GPS), or any other type of location positioning system. As such, the location circuit 120 may receive latitude data, longitude data, and any other type of location or position data to determine the location of the user device 102. In other embodiments, the location circuit 120 may receive an explicit location identification from the user of the user device 102. All such variations are intended to fall within the spirit and scope of the present disclosure.

In some embodiments, the location circuit 120 can monitor the location of the user device 102. For example, the location circuit 120 may transmit a notification to the mobile application 118 when the user has been in a single location/area for a predefined period of time that may indicate the user has completed a transaction (e.g., 5 minutes, 15 minutes, 1 hour, 3 hours). Accordingly, transactions may be inferred by the mobile application 118. In further embodiments, the location circuit 120 can store the location associated with the previous unique value or unique transaction identifier in the memory 114. Based on the stored location, the location circuit can transmit a notification to the mobile application 118 if the current location of the user is different from the stored location for a determined period of time (e.g., 5 minutes, 15 minutes, 1 hour, 3 hours).

The mobile application 118 may update a location associated with the unique value based on the location data indicating that the user device is in the location different from the current user location for either more than a predefined period of time or that the location is separated by more than a predefined distance from the current location. For example, if the user accesses the mobile application 118 X times, but each time corresponds with the same predefined area (e.g., two-square mile radius), the same location that was initially transmitted in the payload may be continuously used thereby avoiding using computing power to update the location. Alternatively, the user device may simply be counted and tracked for the time period in that predefined area. When location data indicates the mobile application 118 was successfully authenticated into an area different from the current location for more than a predefined amount of time (e.g., multiple authentications into the application 118 in a different area or a counter being used to track the time that the user is the different area) and/or that area is located more than a predefined distance from the previous current user location (or, the two areas correspond with different geospatial areas of interest), the new user location may be tracked.

In some embodiments, the location circuit 120 can receive geospatial areas of interest from the provider institution computing system 104 and only transmit a notification to the mobile application 118 when the user has been in a geospatial area of interest for a predefined period of time (e.g., which may indicate that the user has completed a transaction). This avoids fleeting counting, such as if the user takes a train through the geospatial area of interest. For example, the location circuit 120 may determine that a user device 102 has been in a geospatial area of interest for a predefined amount of time. In this instance, the location circuit 120 may notify the mobile application 118, which may infer/determine that a transaction has occurred. In another example, the location circuit 120 may determine that the user device has been in a location outside of a geospatial area of interest for a predefined amount of time. In this instance, the location circuit 120 may not notify the mobile application 118 because the system is not concerned about transactions or location data outside of the geospatial areas of interest. Beneficially, this may reduce computing power used by the mobile application 118.

The input/output circuit 112 is structured to receive communications from and provide communications to the user associated with the user device 102. In this regard, the input/output circuit 112 is structured to exchange data, communications, instructions, etc. with an input/output component of the user device 102. Accordingly, in one embodiment, the input/output circuit 112 includes an input/output device. In another embodiment, the input/output circuit 112 includes communication circuitry for facilitating the exchange of data, values, messages, and the like between an input/output device and the components of the user device 102. In yet another embodiment, the input/output circuit 112 includes machine-readable media for facilitating the exchange of information between an input/output device and the components of the user device 102. In still another embodiment, the input/output circuit 112 includes any combination of hardware components, communication circuitry, and machine-readable media.

In some embodiments, the input/output circuit 112 comprises suitable input/output ports and/or uses an interconnect bus (not shown) for interconnection with a local display (e.g., a touchscreen display) and/or keyboard/mouse devices (when applicable), or the like, serving as a local user interface for programming and/or data entry, retrieval, or manipulation purposes. That is, the input/output circuit 112 provides an interface for the user to interact with various applications (e.g., the mobile application 118) stored on the user device 102.

As shown in FIG. 1, the location data collection and data shred computing system 100 includes a provider computing system 104 (also referred to herein as a provider institution computing system 104). The provider computing system 104 may be structured to receive and store anonymized location and transaction data and, in certain configurations, to shred or delete certain types of data to anonymize the, for example, location data. The provider institution computing system 104 is a computing system owned, associated with, or otherwise operated by a provider (e.g., a financial institution) that provides and maintains one or more accounts (e.g., demand deposit account, credit or debit card account, brokerage account, mortgage account, etc.) on behalf of the user. In the example depicted, the provider institution is a financial institution. In some arrangements, the provider institution is also a mobile wallet provider configured to manage mobile wallet accounts on behalf of its customers (i.e., users), including authenticating mobile wallet transactions involving debits from the users' payment vehicles. For example, the provider institution may also operate the mobile wallet computing system in various embodiments.

The provider computing system 104 is structured as a backend computing system, such as a discrete server, a group of two or more computing devices/servers, a distributed computing network, a cloud computing network, and/or any other type of computing system capable of accessing and communicating using local and/or global networks (e.g., the network 106). The provider computing system 104 includes a network interface circuit 124, a processing circuit 126, an input/output circuit 128, a provider application 134, a user counting circuit 136, and a data analysis circuit 138.

The processing circuit 126 includes a memory 130 coupled to a processor 132. As shown in FIG. 1, the memory 130 is separate from the anonymous user location database 144 and the user database 146. In other embodiments, the memory 130 may include the anonymous user location database 144 and the user database 146. The anonymous user location database 144 is configured to retrievably store user location information void of any PII received from a plurality of user devices 102, as described herein. In this regard, the anonymous user location database 144 is configured to store unique values and unique transaction identifiers associated with location data and/or anonymized transaction data (e.g., merchant name, transaction amount, time of transaction). The user database 146 is configured to retrievably store non-anonymized user information received from a plurality of user devices 102, as described herein. In this regard, the user database 146 is configured to store user location and/or transaction data that can include PII, and user profiles.

The network interface circuit 124 includes program logic that facilitates coupling of the provider computing system 104 to the network 106. The network interface circuit 124 can support communication between the user device 102 and the provider computing system 104. For example, the network interface circuit 124 can include a cellular modem, a Bluetooth transceiver, a radio-frequency identification (RFID) transceiver, and a near-field communication (NFC) transmitter. In some embodiments, the network interface circuit 124 includes the hardware and machine-readable media sufficient to support communication over multiple channels of data communication. Further, in some embodiments, the network interface circuit 124 includes cryptography capabilities to establish a secure or relatively secure communication session between the user device 102 and the provider computing system 104. In this regard, information (e.g., location information, transaction information, PII, and/or other types of data) may be encrypted and transmitted to prevent or substantially prevent a threat of hacking.

The input/output circuit 128 is structured to receive communications from and provide communications to a provider employee, operator, or attendant. In this regard, the input/output circuit 128 is structured to exchange data, communications, instructions, etc. with an input/output component of the provider computing system 104. Accordingly, in one embodiment, the input/output circuit 128 includes an input/output device. In another embodiment, the input/output circuit 128 includes communication circuitry for facilitating the exchange of data, values, messages, and the like between an input/output device and the components of the provider computing system 104. In yet another embodiment, the input/output circuit 128 includes machine-readable media for facilitating the exchange of information between an input/output device and the components of the provider computing system 104. In still another embodiment, the input/output circuit 128 includes any combination of hardware components, communication circuitry, and machine-readable media.

The processor 132 may be implemented as one or more application-specific integrated circuits (ASICs), field-programmable gate arrays (FPGAs), a group of processing components, or other suitable electronic processing components. The memory 130 may be one or more devices (e.g., RAM, ROM, Flash memory, hard disk storage) for storing data and/or computer code for completing and/or facilitating the various processes described herein. The memory 130 may be or include non-transient volatile memory, non-volatile memory, and non-transitory computer storage media. The memory 130 may include database components, object code components, script components, or any other type of information structure for supporting the various activities and information structures described herein. The memory 130 may be communicably coupled to the processor 132 and include computer code or instructions for executing one or more processes described herein. In some embodiments, the provider computing system 104 is a distributed computing system and includes one or more servers. In this case, provider computing system 104 may include multiple network interface circuits 124 and/or multiple processing circuits 126.

In some embodiments, the input/output circuit 128 comprises suitable input/output ports and/or uses an interconnect bus (not shown) for coupling with a local display (e.g., a touchscreen display) and/or keyboard/mouse devices (when applicable), or the like, serving as a local user interface for programming and/or data entry, retrieval, or manipulation purposes. That is, the input/output circuit 128 provides an interface for the user to interact with various applications (e.g., the provider application) stored on the provider computing system. The input/output circuit 128 can allow the provider employee to view and manipulate geospatial areas of interest, anonymized user data, and notifications through the provider application 134

The provider application 134 is a specific application for provider employees, attendants, operators, or other personnel operating the provider application 134 who may not be employees of the provider institution. The provider application 134 may be executed on various provider computing devices (e.g., mobile devices, tablets, computing devices, etc.). The provider application 134 is structured to generate and provide displays to an operator to view and manage the location and other data obtained by the user devices 102. The location data may be provided to the operator via the provider application 134 in a number of forms: counts of users in geospatial areas of interest, heat maps, etc. The provider application 134 is further structured to allow the operator to set or define various particular geospatial areas of interest (e.g., town, strip mall, stadium). For example, the operator may desire to determine the amount of users that attend the games of a particular baseball team and may set a geospatial area of interest surrounding and including the stadium. In further embodiments, the provider computing system 104 may alert the provider employee or operator via the provider application 134 of a particular area of interest, such as ror example, if a large number of users are determined to be in a particular area that is normally not very populated/occupied. The alert can be in the form of a pop-up, a text message to a device of the operator, or an email to an email on record for the operator.

In some embodiments, the provider application 134 is structured to periodically transmit, by the provider computing system 104, keys or limited use keys (LUKs) to the user device 102. The keys or LUKs can be used by the user device 102 to generate the unique value. Based on the keys or LUKs, the provider computing system 104 can authenticate the unique value. As another example, a specific format of the unique value may be used (e.g., sixteen digit, etc.). Beneficially, the use of the keys or LUKs and other specific ways to generate unique values avoids spoofing of these values (i.e., reduce potential for fraud).

The user counting circuit 136 is structured to count user location data in order to determine and track occupancy in various locations. In particular and in some embodiments, the user counting circuit 136 may maintain a counter for each geospatial area of interest. Each counter can have an initial starting value of zero. The counter may be implemented as a computer based counter that counts certain parameters, which in this case, is the location of users in certain areas (e.g., 0, 1, 2, 3, etc.). The user counting circuit 136 is further structured to determine a geospatial area of interest that the user device 102 is located within. When the user counting circuit 136 determines which geospatial area of interest the user is located within (i.e., a match of the current user within the geospatial area of interest), the user counting circuit 136 can then increment the count of users in the determined geospatial area of interest. In some embodiments, the “match” may be based on the user being within the determined geospatial area of interest for a predefined amount of time.

As described above, the use of keys or LUKs to generate the unique value can be used to authenticate the unique value. Once the unique value has been authenticated by the provider computing system 104 (e.g., by verifying the key that generated the unique value), the user counting circuit 136 can determine if the unique value is a duplicate. The duplicate values can be used to increment the counter of a geospatial area of interest, or filtered out thus not incrementing the count. For example, the user counting circuit 136 may store received unique values. When a new unique value is received with a location the same as a previously counted location for that unique value, the user counting circuit 136 may determine it's a duplicate and delete/filter that value. The decision to count or filter duplicate values can be decided by a provider employee through the provider application 134. In some embodiments, the provider employee, by the provider application 134, can decide to allow duplicates if the duplicate is received after a predefined period of time the initial unique value (e.g., 1 minute, 5 minutes, 1 hour).

The count can be cleared or reset (e.g., brought to zero) after a predefined period of time by the user counting circuit 136 (e.g., as set by an operator through the provider application 134). Further, count values for predefined amounts of time may be stored by the memory 130.

The data analysis circuit 138 includes an area determination circuit 140, a response determination circuit 142, an anonymous user location database 144, a user database 146, and a data shredding circuit 148 which are all communicatively coupled. In some embodiments the anonymous user location database 144 and the user database 146 are not communicably coupled. This may be beneficial as it can separate all anonymized user data from any non-anonymized user data.

In some embodiments, the data analysis circuit 138 may parse an incoming data packet from the user device 102. For example, the data analysis circuit 138 may parse, decrypt, or otherwise analyze the payload to determine if it contains a device identifier. In the instances where the data packet does contain a device identifier, the data analysis circuit may separate the device identifier from the other data in the data packet and save the unique value and device identifier in a directory separate from the data analysis circuit 138. This may be beneficial due to the separation from other user PII. While the device identifier does provide some type of identification, other forms of more sensitive information are hidden. Beneficially, with the device identifier (and sometimes the application 118 identifier), the provider computing system 104 may anonymously ping the location of a particular user device 102.

As described herein, the mobile application 118 or provider computing system 104 may infer transaction based on the location information indicating that the user has been in an area corresponding with a known merchant(s). Additionally, the data packet may include an indication of a time regarding how long the user device has been in an area. Upon the user successfully authenticating into the mobile application 118, the location of the user may be tracked. When the user exits the mobile application 118 (e.g., closes their phone, exits the app, etc.), the tracked location information is converted into an area by either the mobile application or the provider computing system 104 (e.g., they started at mile marker 34 and ended at mile marker 38 of interstate XX, which corresponds with a 4 mile area). Further, a time of travel in this area is determined by the mobile application 118. In this regard, the mobile application 118 may include a counter that initiates upon a successful authentication into the mobile application 118. Then, the provider computing system 104 compares this converted location area to a geospatial area of interest. If a majority or a predefined value of the converted area corresponds to a geospatial area of interest (e.g., 2.1 mile area from above is within a single geospatial area of interest), then the provider computing system 104 increments a counter for that area of interest indicating that the user was present (i.e., a determines a match of the user location to the area and increments a counter for that area). In other embodiments, time may not be used such that the provider computing system 104 receives a data packet that indicates a location of the user when he/she was first successfully authenticated into the mobile application 118.

The area determination circuit 140 is structured to determine a geospatial area of interest. A geospatial area of interest, as described herein is a geographic area of interest that is of interest in learning about how many people frequent that area. The geospatial area of interest can include geographic data as well as data including data about businesses within the area (e.g., business name, type of business), public transportation through the area, etc. The geospatial area of interest may also be referred to as an area of interest, a predefined area of interest, and a geofenced area of interest. An initial determination of an area of interest may be from a provider employee input (e.g., interest in adding an ATM to the area, possibly adding a new branch), a user location in a new region, or increased access in a new area. For example, a once large area may be split into two areas when more users access the mobile application 118 in two particular areas of the once larger area. It should be appreciated that there may be many other reasons that the area determination circuit 140 may decide to generate a new geospatial area of interest.

In some embodiments, the area determination circuit 140 may create geospatial areas of interest automatically using data solely from the payloads. This can be done by analyzing user location data from the anonymous user location database 144 to determine a requisite amount of users (a threshold value of people may be required before an “area of interest” is designated) as set by a provider employee through the provider application 134, in a common area (e.g., a two square miles). This analysis can be completed continuously, daily, weekly, etc. In further embodiments, the area determination circuit 140 may create geospatial areas of interest using data solely from unique transaction indicators that are generated when the user completes a transaction at a business. The area determination circuit 140 may analyze user location data from the anonymous user location database 144 to determine a requisite amount of users, as set by a provider employee through the provider application 134, have been authenticated through the mobile application 118 in a common area (e.g., 1 mile radius). This analysis can be completed continuously, daily, weekly, etc.

In some embodiments, the geospatial areas of interest are static. For example, the geospatial areas of interest do not change with time. In this example, the incoming location data and unique values are used to increment a counter in a set geospatial area of interest.

The area determination circuit 140 may further be structured to modify a geospatial area of interest (i.e., the areas of interest are dynamic in nature). For example, the area determination circuit 140 may specify or adjust a geospatial area of interest as more data is acquired (e.g., enlarge a geospatial area of interest as access/transactions expand (e.g., more businesses open), etc.). In one embodiment, the area determination circuit 140 may enlarge a geospatial area of interest. For example, the provider computing system 104 may receive a requisite amount of unique transaction indicators, as set by a provider employee through the provider application 134, at a location outside of a geospatial area of interest. In this instance, the area determination circuit 140 may create a second geospatial area of interest, as described above, that overlaps with a current geospatial area of interest. Alternatively, the geospatial area is enlarged to include the location outside of the geospatial area of interest. The area determination circuit 140 may also reduce the area of a geospatial area of interest. For example, a geospatial area of interest may initially cover a specific area. In this instance, unique transaction identifiers, which identify the occurrence of a transaction may only be received for a certain sub-area of the original geospatial area of interest (e.g., a business district). Based on this information, the area determination circuit can reduce the geospatial area of interest to only correspond to this “utilized” area. This can be beneficial to pinpoint areas where a high volume of users complete purchases or are authenticated through the mobile application 118.

The area determination circuit 140 may have separate geospatial areas of interest for incoming data depending on whether the data is a unique value or a unique transaction indicator. For example, a unique transaction indicator may increment the count of a transaction geospatial area of interest, while a unique value may increment the count of a non-transaction geospatial area of interest. The separate geospatial areas of interest can be used for different purposes. For example, a transaction geospatial area of interest that is incremented by unique values may be used to determine where an ATM should be located. In another example, a non-transaction geospatial area of interest may be used by the provider institution or by other entities, such as marketing companies or real estate companies, to determine where users visit.

In some embodiments, the area determination circuit 140 may receive the user data from the user counting circuit 136 and transmit said data to the determined database. If the data is determined to have non-anonymized data, the area determination circuit may add it to the user database 146. If the data is determined to be anonymized data, the area determination circuit may add it to the anonymous user location database 144. In these instances, the area determination circuit 140 may also transmit the user data to the response determination circuit 142.

In some embodiments, the anonymous user data is sorted into a specific geospatial area of interest based on the associated location. This can be beneficial as by presorting the data, the provider computing system 104 can reduce the amount of data that must be sorted, filtered, or queried as needed by the provider employee or external entity (e.g., marketing firm).

The response determination circuit 142 is structured to analyze the incoming location and transaction data from the user counting circuit 136, the geospatial areas of interest from the area determination circuit 140, non-anonymized user location and transaction data from the user database 146 and anonymized user location and transaction data from the anonymous user location database 144.

The response determination circuit 142 is structured to analyze non-anonymized location and transaction data. In these instances, the response determination circuit 142 may generate a user profile based on the non-anonymized data of a user received from the mobile application 118 and store/add it to the user database 146. The user profile can include demographic information provided by the user to the mobile application 118 through the user device 102 such as age, gender, race, ethnicity, etc. (or via another way, such as when he or she became a client of the provider and filled out paperwork in person or online). The user profile can further include generalized information relating to previous user location information and user transaction information. The generalization can include placing transactions depending on a determined merchant into categories (e.g., sporting goods, restaurants). The generalization or shredding process entails deleting particular information to reduce storage requirements. For example, the transaction data originally received with a particular merchant name, transaction value, means by which the purchase was made (e.g., physical card, mobile wallet transaction), transaction account number) can be saved as a category of transaction and the time it occurred.

In some embodiments, the profile can include transaction information that describes what types of stores or restaurants the user frequents, and how frequently the user completes transactions at these merchants. In some embodiments, the user profile can contain generalized information relating to the number of times a user has completed transactions or visited a certain merchant or type of merchant. For example, the user profile can include an enumerated list showing the user has visited sporting goods stores 16 times in the last year, where the user completed transactions 12 times. The user profile can be updated as new data is received from the mobile application 118.

The response determination circuit 142 may determine interests of the user based on transaction data and/or location data. These interest may include hobbies (e.g., watching baseball games, golfing, visiting movie theatres, traveling), commonly frequented restaurants or stores, and son. The interests can be determined by the transaction data and/or location data received by the user device 102. For example, the user may have completed transactions at golf courses X times in the last year. Based on this information, the circuit 142 determines that the user is interested in golf The interests of the user may be updated as more location and transaction data is provided. For example, if a transaction has not been categorized in a previously determined interest of the user in a set period of time (e.g., 3 months, 6 months, 1 year) the interest can be removed from the user profile. Based on the user profile information, the response determination circuit 142 may determine rewards available to the user.

In some embodiments, the response determination circuit 142 is structured to determine patterns or trends in user transaction and/or location data. The response determination circuit 142 may analyze the particular category a transaction is determined to be within and associate it with the time and/or date received in the data packet. For example, in the months of December through February, the user may complete transactions at ski hills, but not complete any transactions at ski hills for the other months of the year. In this instance, the response determination circuit 142 may determine that the user has an interest in skiing. Based on this information, the response determination circuit 142 may determine skiing rewards for the user. In another example, the user may complete transactions at restaurants only on Fridays and Saturdays. In this instance, the response determination circuit 142 may determine the user has an interest in dining. Based on this information, the response determination circuit 142 may determine dining rewards for the user.

Based on the determined rewards, the response determination circuit 142 may transmit a notification to the user device 102 via the application 118 that the user has been given a reward for a determined merchant. The notification can be a notification through the mobile application 118. In some embodiments, the non-anonymized data can include a phone number of the user and/or email. In these instances, the notification can include text messages and/or email notifications. Rewards available to the user may include a certain percentage off the user's next purchase, rewards points that may be redeemed for free items or converted into currency for further purchases, etc. For example, the user has been to three baseball games in the last two months. In this instance, the user may receive a predefined percentage off the entrance fee to the next attended baseball game. The rewards available to the user may include a certain percentage off the user's next purchase, rewards points that may be redeemed for free items or converted into money for further purchases, etc. It should be appreciated that these do not represent all of the reward opportunities available to the user. The rewards as described above can be rewards provided by a particular merchant for returning customers (e.g., loyalty points). In some embodiments, a provider that maintains the provider computing system 104 may provide rewards to the user. For example, rewards may be provided to users who use a particular account frequently. In further embodiments, the provider may provide rewards to a user in an area of interest of the user to promote continued use of a particular account.

The response determination circuit 142 may further be structured to alert a provider employee or operator operating the provider application 134 of a large spike in users in a particular area. The particular area can be in a geospatial area of interest or outside of a geospatial area of interest. The “large spike” can be determined by the response determination circuit 142 comparing the previous count in a geospatial area of interest and determining that a subsequent count is beyond a threshold value (e.g., 100% higher than normal count, 500% higher than normal count). For example, in the case of a wild fire, many people may be displaced and need to withdraw money from their bank accounts. In this instance, a provider employee may be notified of a large increase of users in a certain area. Based on the notification, the response determination circuit 142 can suggest various products or services, such as an ATM, to allow the users to withdraw money in an area with a normally low user count.

The response determination circuit 142 can incorporate artificial intelligence (AI) models. For example, the response determination circuit 142 may be configured to incorporate artificial intelligence models to study the location and/or transaction data received from a plurality of user devices 102 and determine responses. The response determination circuit 142 can utilize historical data and responses and/or pre-gathered training data (e.g., from a third party software company) to learn to identify potential responses to the received location and/or transaction data. Additionally or alternatively, the response determination circuit 142 can utilize pre-trained AI models obtained or accessed via an API or other communication method.

In some embodiments, the response determination circuit 142 may utilize unique values and unique transaction indicators differently. For example, the response determination circuit 142 may track unique values, which are generated when the user is authenticated through the mobile application 118, to determine where financial institution infrastructure (e.g., bank branches, ATMs) may be best used.

In some embodiments, the response determination circuit 142 may instruct the mobile application 118 to track the location of the user device 102 for a predetermined period of time (as set by an operator of the provider computing system 104). For example, the response determination circuit 142 have the information for the application 118 based on the initial transmission to the provider computing system 104 to send an instruction to the mobile application 118. For example, a provider employee, through the provider computing system 104, may desire to determine where users who shop at a particular merchant also shop. In this instance, the unique transaction indicators can be used to anonymously determine which merchants the users also visit or complete transactions. It should be appreciated that alone, or in combination, the response determination circuit 142 may use the data from the unique values and unique transaction indicators for a multitude of other purposes.

The response determination circuit 142 is structured to analyze trends in user location data from the anonymous user location database 144 and determine possible areas of expansion in the financial institution infrastructure (e.g., bank branches, ATMs). For example, the response determination circuit 142 may determine that the number of users providing log-in credentials in a particular area has increased recently (e.g., in the last month, in the last year, in the last 5 years). In this instance, the response determination circuit 142 may determine that an ATM or branch should be added, or built in that general area.

The response determination circuit 142 is structured to analyze customers who complete transactions at a particular business, or in a particular area. For example a provider employee may flag a particular business, or a specific area of interest to determine more information about the customers that shop there or in that area. In this instance, the response determination circuit 142 may prompt the mobile application 118 to regularly (e.g., every 5 minutes, 10 minutes, 30 minutes) update the location of the user for a set period of time (e.g., 1 hour, 2 hours, 5 hours) to allow the response determination circuit 142 to determine other areas that are often visited by users who complete transactions at the flagged business, or area of interest.

In further embodiments, the response determination circuit 142 may ping the location of a user device 102 by accessing a directory of unique values and unique transaction indicators. The directory of unique values and unique transaction indicators may be saved within the anonymous user location database 144 or outside of the data analysis circuit 138. The directory may maintain the device ID that is associated with a unique value or unique transaction indicator either for a defined period of time or indefinitely.

The response determination circuit 142 may ping the user device 102 associated with a unique value. For example, the provider computing system 104 may desire to provide a mass notice to those in a certain area. In these instances, the provider computing system 104 may contact users in a determined area by transmitting a notification to the corresponding user devices 102. For example, a provider may close branches in a certain area due to an impending hurricane. The provider computing system 104 may ping identified user devices 102 in the area surrounding the closed branches.

The anonymous user location database 144 is structured to selectively maintain anonymous user location and transaction data. In further embodiments, the anonymous user location database 144 may also store the directory that links the unique value or unique transaction indicator to a device ID associated with user device(s) (or other data identifying the user device and/or mobile application 118). In some embodiments, the anonymous user location data is stored in the anonymous user location database 144 depending on the geospatial area of interest that the current user location falls within.

The user database 146 is structured to selectively maintain the non-anonymized user location and transaction data. In further embodiments, the user database 146 may also store user profiles. The user profiles may be updated by the response determination circuit 142 as new user data is provided. The user interests of the user profile may be updated by incrementing a tally on the locations or types of purchase the user completes, along with the location data provided. It should be appreciated that the user interests of the user profile may be updated by other methods.

The data shredding circuit 148 is structured to shred certain data. In particular, the data shredding circuit 148 is structured to shred or delete certain data after a preset period of time, which may be set by an operator of the provider application 134 (e.g., 30 minutes, 2 hours, 1 day, 1 week, 1 month, 1 year). The data can be shredded by deleting the data from all memory sources. For example, the data shredding circuit 148 may shred all user data pertaining to a transaction that was completed a preset duration of time in the past. In some embodiments, the data shredding circuit 148 is structured to shred all unique values, unique transaction identifiers, and user location data after the counter(s) have been incremented. This can be beneficial as it reduces the memory storage requirements of the provider computing system 104.

In some embodiments, the data shredding circuit 148 may only shred the non-anonymized user location and transaction data after the determined period of time. For example, in the embodiments where the user authorizes the mobile application 118 to transmit PII to the provider computing system 104, the data shredding circuit can shred all PII and maintain the anonymized data after a determined period of time. The determined period of time may be set by the user when authorizing the mobile application 118 to transfer PII to the provider computing system. In lieu of a determined period of time set by the user, the operator of the provider application 134 can set a period of time, as described above. Upon shredding the non-anonymized data, the remaining anonymized data can be transmitted and stored in the anonymous user location database 144. Beneficially, by shredding the non-anonymized data and maintaining the anonymized data, the risk of a breach of non-anonymized user data is reduced. Additionally, this can be beneficial as it reduces the memory storage requirements and maintains anonymized data that can be used to anonymously determine trends in user location and/or transaction data.

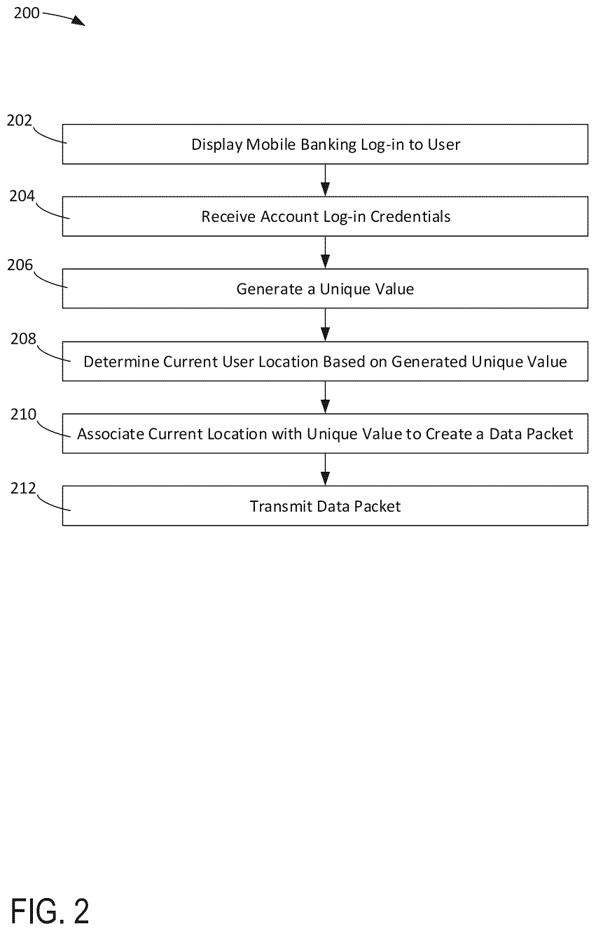

Referring now to FIG. 2, a flow diagram of method 200 for anonymizing and transmitting location data, according to example embodiments. The method may be performed by the components of FIG. 1, such that reference is made to one or more components of FIG. 1 to aid explanation of the method 200. The method 200 is initiated by the mobile application 118 displaying a graphical user interface including an area for an input of log-in credentials by a display of the user device 102 at process 202. The mobile application 118 may require the user to input a username and password, biometric data, account identifier and PIN, etc. At process 204, the user device 102 receives the account log-in credentials via the input/output circuit 112 and cross-references the received account log-in credentials with stored log-in credentials. In some embodiments, the mobile application 118 can determine an unsuccessful log-in by an inability to cross-reference the received log-in credentials with stored log-in credentials.

At process 206, the mobile application 118 generates a unique value. The mobile application 118 may maintain a unique value for a period of time after the generation of the unique value (e.g., 1 hour, 2 hours, 5 hours, next prompt from the mobile application 118). In some embodiments, the user may be assigned a single unique value that may be used indefinitely. For example, when the user first accesses the mobile application 118 on a user device 102, the mobile application 118 may generate a unique value that is then stored in the mobile application 118. The unique value may then be transmitted with updated location data (i.e., the payload) every or nearly every time the user accesses the mobile application 118. In some embodiments, the unique value may be originally transmitted with a device identifier to the provider computing system 104. In these instances, the provider computing system 104 may then hold this information separate from location data. In some embodiments, the provider computing system 104 may then ping the location of the user device 102 by referencing the unique value that is associated with a particular user device 102.

At process 208, the user device 102 determines the current user location (e.g., via the location circuit 120) based on a unique value being generated. The location may be determined by a global positioning system (GPS) in the user device 102, a determination based on a Wi-Fi connection, etc. The current location of the user may be represented by a latitude and longitude, approximate address, nearest merchant, etc.

At process 210, the user device 102 associates the current user location with the unique value. A data packet is created or generated by the mobile application 118 to include the user location and the unique value. In some embodiments, the data packet may also include a device identifier (e.g., phone number, device ID). In further embodiments, the packet may include other information (e.g., time). At process 212, the mobile application 118 via the user device 102 transmits the data packet including the location and unique value to the provider computing system 104.

Based on the foregoing description, a summary of the method 200 can be described as follows. On a generated graphical user interface of the user device 102, the user enters credentials. Upon receiving the credentials of the user, the mobile application 118 authenticates the user. Upon a successful authentication of the user, a unique value is generated by the mobile application 118 and associated with current location of the user device 102. The data packet including the unique value and the associated location (i.e., the payload) is transmitted to the provider computing system 104. Upon receiving the payload, the provider computing system 104 verifies the authenticity of the unique value. Once verified such as by the format of the unique value matching an acceptable format standard, the location information is tracked anonymously by the provider computing system 104. In this regard, the payload does not include PII and, hence, location information for authenticated users may be tracked anonymously. The authentication of the user is useful to confirm that a person exists in combination with being able to track location information anonymously.

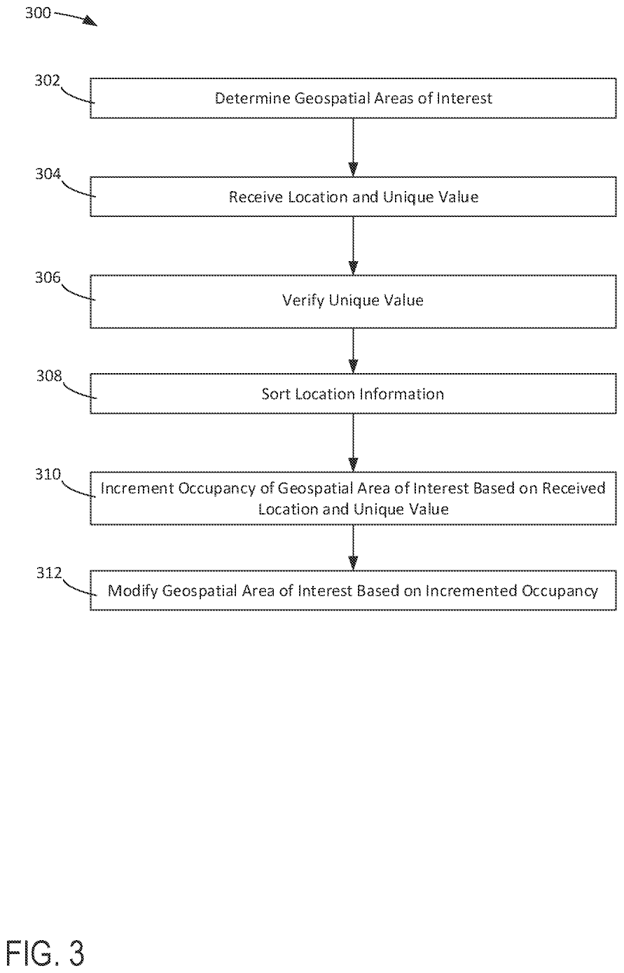

Referring now to FIG. 3, a flow diagram of method 300 for incrementing a counter and modifying geospatial areas of interest to more particularly define areas of interest of a plurality of users is shown, according to an example embodiment. The method may be performed by the components of FIG. 1, such that reference is made to one or more components of FIG. 1 to aid explanation of the method 300. The method 300 may be initiated at process 302 by the area determination circuit 140 determining a plurality of geospatial areas of interest. In some embodiments, the geospatial areas of interest are based on user location and transaction information. In some embodiments, the area of interest may be defined by an operator. For example, the operator may be interested in a particular region to determine whether an ATM or a branch could be supported there.

In some embodiments, the process can further include the provider computing system 104 providing a plurality of provider institution client applications 118 to a plurality of user devices 102. This can be done by transmitting a hyperlink allowing the user to access a web-based interface application via the user device 102, transmitting a hyperlink allowing the user to download the provider institution client applications 118 on the user device 102, etc. The provider institution client application 118 can then be deployed by the user device 102 for further use.

At process 304, the provider computing system 104 receives a location associated with a unique value from a user device 102 (a payload). In some embodiments, the unique value can be a unique transaction indicator included in the payload.

At process 306, the provider computing system 104 verifies the unique value received from the user device 102. In some embodiments, a specific format of the unique value may be prescribed/designated thereby allowing for the unique value to be verified by the provider computing system 104. For example, keys or limited use keys may be periodically transmitted to the user device 102 that are used to generate the unique value. Based on the key or limited used key, the provider can authenticate the unique value. As another example, a specific format of the unique value may be used (e.g., sixteen digit, etc.). Beneficially, the use of the key or limited use key and other specific ways to generate unique values avoids spoofing of these values.

Upon verifying the unique value, the provider computing system 104 sorts the received location information, at process 308, to correlate the received location information to the determined plurality of initial geospatial areas of interest from process 302. The provider computing system compares the received location information with the areas defined by the plurality of geospatial areas of interest to determine which, if any, of the determined geospatial areas of interest that the received location information falls within (i.e., a match). The provider computing system 104 determines a “match” based on the location information falling with a determined geospatial area of interest. In some embodiments, the location of the user may not fall within a determined geospatial area of interest. In these instances, a geospatial area of interest may be added to the anonymous user location database 144 for future reference and not counted in a geospatial area of interest.

At process 310, the provider computing system 104 increments a counter representing the occupancy of the geospatial area of interest that the user location is determined to be within. The counter indicative of occupancy may increment for a desired period of time (e.g., 1 hour, 1 day, 1 week), as determined by an operator of the provider application 134, and then be cleared. In some embodiments, the counter associated with the user location is incremented. Then, when other users are determined in or near that location (e.g., within a predefined distance of that area), the counter increments the count for that location.

At process 312, the provider computing system 104 modifies at least one geospatial area of interest of the determined plurality of initial geospatial areas of interest based on the sorted and received location information. For example, the provider computing system 104 may adjust a geospatial area of interest as more data is acquired. For example, the provider computing system 104 may enlarge a geospatial area of interest. For example, the provider computing system 104 may receive a requisite amount of unique transaction indicators, as set by a provider employee through the provider application 134, at a location outside of a geospatial area of interest. In this instance, the provider computing system 104 may create a second geospatial area of interest or enlarge the adjacent geospatial area of interest.

Alternatively, at process 312, the provider computing system 104 may reduce the size of the geospatial of interest. For example, if a certain threshold area subsection (e.g., one city block, an area of 12 square mile) of a geospatial area of interest does not receive a unique value and/or unique transaction identifier associated with a location within the subsection of the geospatial area of interest in a predetermined period of time, the subsection is removed from the geospatial area of interest by the provider computing system 104 thereby shrinking that particular geospatial area of interest.

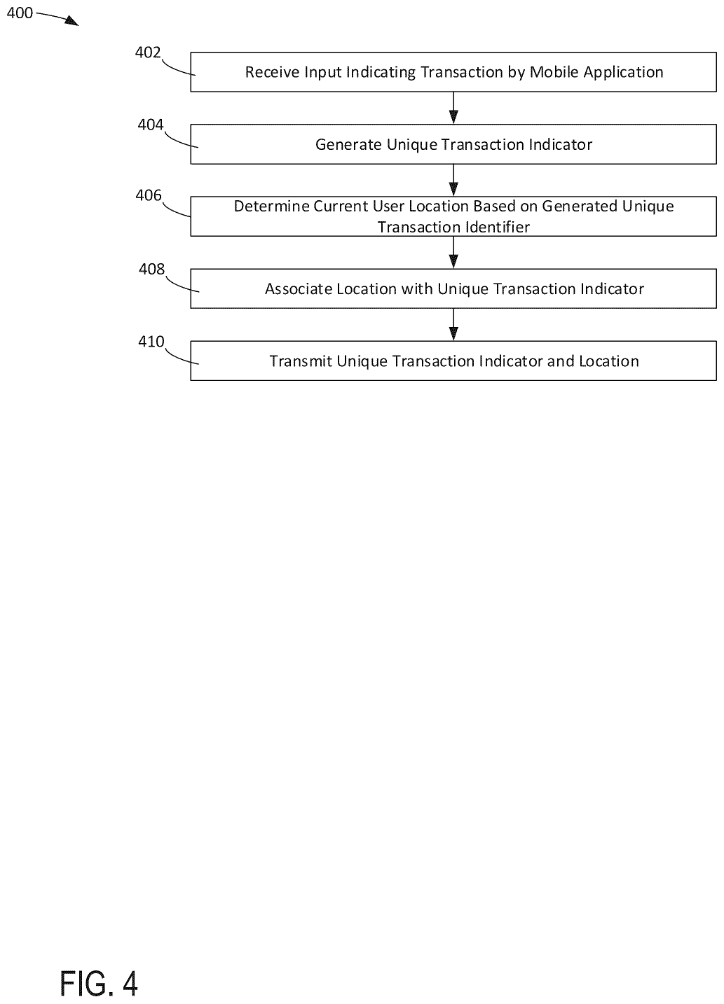

Referring now to FIG. 4 a flow diagram of a method for anonymizing and transmitting transaction data is shown, according to an example embodiment. The method may be performed by the components of FIG. 1, such that reference is made to one or more components of FIG. 1 to aid explanation of the method 400. The method 400 is initiated by process 402 by the mobile application 118 receiving an indication that a transaction has been completed by the user. For example, the mobile application 118 is a part of or includes a mobile wallet application. In these instances, the mobile application 118 can be notified by a binary indicator that a transaction has been completed. For example, the mobile application 118 can receive a notification that a transaction has been completed by the user void of any transaction specific information. Additionally or alternatively, the mobile application 118 can infer that a transaction has occurred. For example, the location circuit 120 can notify the mobile application 118 that the user device 102 has been in a particular geospatial area of interest for a period of time. Based on this information correlating with a known merchant location, the mobile application 118 can infer that a transaction has occurred. Alternatively, the provider computing system 104 can infer transactions based on using a database of known merchant locations relative to the received location information: for example, if the location information indicates that a person was in a predefined area for a certain amount of time which corresponds with a merchant location, a transaction may be inferred by the system 104.

At process 404, a unique transaction identifier is generated by the mobile application 118. The mobile application 118 may maintain a unique transaction identifier for a period of time after the generation of the unique transaction identifier (e.g., 1 hour, 2 hours, 5 hours, next prompt from the mobile application 118). In some embodiments, the user may be assigned a single unique transaction identifier that may be used indefinitely. For example, when the user completes a first transaction the mobile application 118 on a user device 102 may generate a unique transaction identifier that is then stored in the mobile application 118. The unique transaction identifier may then be transmitted with updated location data (i.e., the payload) every or nearly every time the user completes, or is suspected to have completed a transaction. In some embodiments, the unique transaction identifier may be originally transmitted with a device identifier to the provider computing system 104. In these instances, the provider computing system 104 may then hold this information separate from location data. In some embodiments, the provider computing system 104 may then ping the location of the user device 102 by referencing the unique transaction identifier that is associated with a particular user device 102.

At process 406, the mobile application 118, via the location circuit 120, determines the current user location based on a transaction identifier being generated. The location may be determined by a global positioning system (GPS) in the user device 102, a determination based on a Wi-Fi connection, etc. The current location of the user may be represented by a latitude and longitude, approximate address, nearest merchant, etc.

At process 408, the mobile application 118 associates the current user location with the unique transaction identifier. The mobile application 118 packages this information together in a data packet. In some embodiments, the data packet may also include a device identifier (e.g., phone number, device ID). In further embodiments, the packet may include other information (e.g., time information, transaction information). At process 410, the mobile application 118, via user device 102, transmits the data packet to the provider computing system 104.

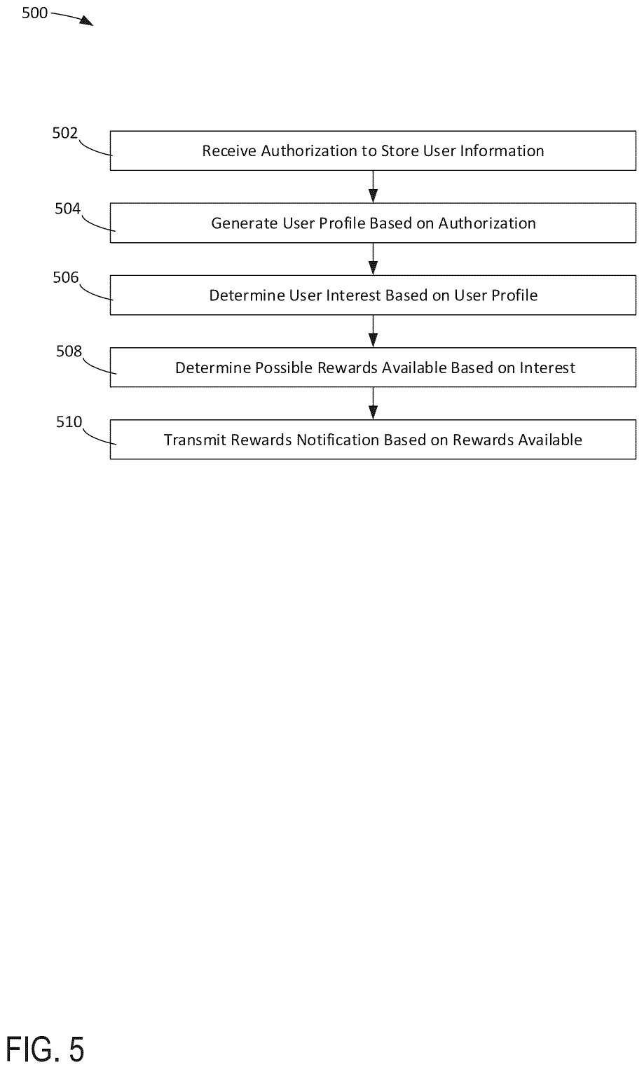

Referring to FIG. 5 a flow diagram of a method for transmitting rewards to a user device 102 based on user location is shown, according to an example embodiment. The method may be performed by the components of FIG. 1, such that reference is made to one or more components of FIG. 1 to aid explanation of the method 500. The method 500 is initiated at process 508 by provider computing system 104 receiving authorization to store user PII from the mobile application 118. For example, the authorization can include specifications as to what user information can be transmitted to the provider computing system, and how long the information can be stored before it must be shredded.

Upon receiving authorization to store user information, the provider computing system 104 can store non-anonymized location and/or transaction data received from the user device, as described above.

At process 504, the provider computing system 104 generates a user profile for the user based on received demographic information as well as received location and/or transaction data. For example, the user profile can include the age and gender of the user. Additionally the user profile can include places the user commonly visits, and particular merchants, or categories of merchants where the user frequently completes transactions.

At process 506, the provider computing system 104 determines interest(s) of the user based on the user profile and subsequent information received from the mobile application 118. These interest may include hobbies (e.g., watching baseball games, golfing, visiting movie theatres, traveling), commonly frequented restaurants or stores, etc. The interest(s) are continuously updated. For example, the interest(s) of the user can be determined based on location and/or transaction data received within a predetermined period of time as set by an operator of the provider computing system 104. For example, if the transaction information indicates that the user frequents Merchant X and Restaurant Y more than a preset number of times in a predefined time period, then the provider institution computing system 104 determines that these places are interests of the user. Further, the provider computing system 104 may also then determine similar types of merchants and restaurants (e.g., based on the merchants having the same merchant category code) that are also determined to likely be an interest of the user. This may be filtered based on these additional places being within a predefined distance of a “home” of the user (e.g., one-hundred miles).

At process 508, the provider computing system 104 determines possible rewards available to the user based on the interests determined at process 506. The rewards can be provided to the user based on a current location of the user device. For example, based on a current location received with a unique value or unique transaction identifier, the provider computing system 104 can determine rewards in the general vicinity of the user device 102 that relate to the interests of the user.

At process 510, the provider computing system 104 transmits a notification to the user device 102 indicating the availability of rewards at locations at or around the current location of the user. In some embodiments, the notification is transmitted to the mobile application 118. In further embodiments, the notification may be transmitted to the user by a text message and/or email. In some embodiments, the mobile application 118 may be configured to maintain the rewards for future use.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors is structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

1. A computing system for anonymizing user data, the computing system comprising:
a user device including a network interface coupled to a processing circuit, the network interface structured to facilitate data communication with a provider computing system via a network, the processing circuit including a processor coupled to a memory storing instructions that, when executed by the processor, cause the processing circuit to perform operations including:
display a mobile application graphical user interface depicting a field for a log-in credential;
receive a log-in credential of a user associated with the mobile application and cross-reference the received log-in credential with a stored log-in credential to successfully authenticate the user into the mobile application;
based on the successful authentication, generate a unique value void of personally identifiable information regarding the user;
determine a current user location based on location data associated with the user device;
associate the current user location with the unique value to create a data packet; and
transmit the data packet to the provider computing system to quantify a number of users in a predefined area.

2. The system of claim 1, wherein the instructions, when executed by the processor, further cause the processing circuit to perform operations including:
update a location associated with the unique value based on the location data indicating that the user device is in the location different from the current user location for either more than a predefined period of time or that the location is separated by more than a predefined distance from the current location.

3. The system of claim 1, wherein the unique value is one of a numeric or alphanumeric code.

4. The system of claim 1, wherein the instructions, when executed by the processor, further cause the processing circuit to perform operations including:
receive a ping from the provider computing system requesting an updated location of the user device; and
transmit the updated location associated with the unique value in response to the ping.

5. The system of claim 1, wherein the instructions, when executed by the processor, further cause the processing circuit to perform operations including:
determine an unsuccessful authentication into the mobile application and not generate the unique value.

6. The system of claim 1, wherein the instructions, when executed by the processor, further cause the processing circuit to perform operations including:
determine that the user has completed a transaction based on accessing a mobile wallet application or determining that the current user location is at or near a location of a merchant and that the user device has been at the current user location for more than a predefined amount of time;
generate a unique transaction indicator indicative of the transaction by the user;
associate a location of the completed transaction with the unique transaction indicator; and
transmit the associated unique transaction indicator and the associated location to the provider computing system.

7. A method for anonymizing user location information, the method comprising:
determining and maintaining, by a provider computing system, a plurality of geospatial areas of interest;
providing, by the provider computing system, a plurality of provider institution client applications to a plurality of user devices;
causing, by the provider computing system responsive to transmitting a plurality of keys to the plurality of user devices, the plurality of user devices to generate a plurality of unique values using the plurality of keys:
based on a successful authentication into a provider institution client application of the plurality of provider institution client applications, receiving, by the provider computing system, a data packet including a unique value of the plurality of unique values and a current location of a user device of the plurality of user devices associated with the provider institution client application that was successfully authenticated into, the unique value generated by the user device using a first key of the plurality of keys previously transmitted by the provider computing system, the unique value void of personally identifiable information regarding a user associated with the user device, and the unique value decryptable using the first key of the plurality of keys previously transmitted by the provider computing system;
matching, by the provider computing system, the current location of the user device to a geospatial area of interest of the plurality of geospatial areas of interest based on determining that the current location of the user device is within the geospatial area of interest;
incrementing, by the provider computing system, a counter regarding an occupancy of the geospatial area of interest based on the match;
determining, by the provider computing system responsive to receiving the unique value, that a number of uses of the unique value exceeds a threshold; and
transmitting, by the provider computing system, a second key to the user device that causes the user device to:
delete the first key from the user device; and
generate a second unique value using the second key.

8. The method of claim 7, further comprising in response to determining that the current location does not match any of the plurality of geospatial areas of interest, shredding, by the provider computing system, the unique value and the current location of the user device.

9. The method of claim 7, further comprising:
modifying, by the provider computing system, the geospatial area of interest based on the current location of the user device relative to the geospatial area of interest.

10. The method of claim 7, further comprising:
instructing, by the provider computing system, the user device to track the current location of the user device associated with the second unique value for a predetermined period of time.

11. The method of claim 7, further comprising:
shredding, by the provider computing system, the unique value and the current location after incrementing the counter.

12. The method of claim 7, further comprising:
receiving, by the provider computing system, permission to hold user personally identifiable information for a predetermined period of time before shredding the personally identifiable information.

13. The method of claim 12, further comprising:
generating, by the provider computing system, a user profile, wherein the user profile includes user age, user gender, a record of previous locations, and a record of previous transactions;
determining, by the provider computing system, a user interest of the user based on the user profile;
determining, by the provider computing system, rewards for the user based on the user interest; and
transmitting, by the provider computing system to the user device, a notification of the rewards available to the user based on the current location of the user device.

14. The method of claim 7, further comprising:
pinging, by the provider computing system, the user device to obtain an updated location associated with the second unique value.

15. A system, comprising:
a provider computing system comprising a network interface and a processing circuit, the network interface structured to facilitate communication with a plurality of user devices via a network, the processing circuit comprising a processor and a memory storing instructions that, when executed by the processor, cause the processing circuit to:
determine a plurality of geospatial areas of interest;
cause, responsive to transmission of a plurality of keys to the plurality of user devices, the plurality of user devices to generate a plurality of unique values using the plurality of keys:
receive, from a user device of the plurality of user devices, a data packet including a unique value of the plurality of unique values and location information regarding a location of the user device of the plurality of user devices based on a successful authentication into a provider institution client application of the user device, the unique value generated by the user device using a first key of the plurality of keys previously transmitted by the provider computing system, the unique value void of any personally identifiable information regarding a user associated with the user device, and the unique value decryptable using the first key of the plurality of keys previously transmitted by the provider computing system;
verify the unique value generated by the user device of the plurality of user devices;
sort the location information regarding the location of the user device to correlate the location information regarding the location of the user device to a geospatial area of interest of the plurality of geospatial areas of interest;
increment an occupancy counter for the geospatial area of interest based on the location information regarding the location of the user device to track occupancy in the geospatial area of interest;
determine, responsive to verifying the unique value, that a number of uses of the unique value exceeds a threshold; and
transmit a second key to the user device that causes the user device to:
delete the first key from the user device; and
generate a second unique value using the second key.

16. The system of claim 15, wherein the instructions, when executed by the processor, further cause the processing circuit to transmit a limited use key to at least one user device that is configured to generate a third unique value from the at least one user device, and receive and verify the third unique value from the at least one user device based on the limited use key.

17. The system of claim 15, wherein the instructions, when executed by the processor, further cause the processing circuit to shred the unique value and the location information regarding the location of the user device after incrementing the occupancy counter.

18. The system of claim 15, wherein the instructions, when executed by the processor, further cause the processing circuit to modify the geospatial area of interest based the location information regarding the location of the user device.

19. The system of claim 15, wherein the instructions, when executed by the processor, further cause the processing circuit to receive a unique transaction identifier to anonymously indicate a location of a transaction.

20. The system of claim 15, wherein the instructions, when executed by the processor, further cause the processing circuit to match the location information regarding the location of the user device with known merchant locations and infer a transaction based on the location information regarding the location of the user device and the known merchant locations.
